(19) United States
(12) Patent Application Publication
(10) Pub. No.: US 2007/0277443 A1
(43) Pub. Date: Dec. 6, 2007

(54) Motorized sliding window pane

(75) Inventors: Sabin Dery, Laval (CA); Rejean Daoust, Valleyfield (CA); Gino Grondin, Vaudreuil (CA)

Correspondence Address: OGILVY RENAULT LLP, 1981 MCGILL COLLEGE AVENUE, SUITE 1600, MONTREAL, QC, H3A2Y3, US

(73) Assignee: Pyramid Specialty Products Ltd.

(21) Appl. No.: 11/455,848

(22) Filed: Jun. 20, 2006

(30) Foreign Application Priority Data
Jun. 2, 2006 (CA) 2,535,272

(51) Int. Cl. E05F 11/00

(52) U.S. Cl. 49/413; 49/360

(57) ABSTRACT

A sliding window pane, particularly, but not exclusively, for a motorized vehicle conductor window is described. The sliding window pane is disposed in a window structure having a frame. The frame has a fixed window pane with an opening therein. A secondary frame is provided adjacent an interior surface of the fixed window pane. The sliding window pane has opposed rails secured thereto slidingly connected to opposed channel frame members of the secondary frame. A flexible attachment cable extends in one of the opposed channel frame members and has a connector for connection to the rail associated therewith. An electrical motor is operable by a switch to displace the attachment cable thereby displacing the sliding window pane between the opposed frame members to cover or expose the opening or part thereof.

### TECHNICAL FIELD

The present invention relates to a sliding window pane and more particularly, but not exclusively, to a sliding window pane to cover or expose an opening in a window.

### BACKGROUND ART

Various types of sliding window panes are known and in a related application being filed concurrently herewith, and entitled “Motorized In-Line Sliding Window”, there is described an in-line window frame which is displaceable in and out of an opening of a window by means of a pair of concealed cables which are displaced by an electric motor which is also concealed in a structure adjacent the window frame.

The sliding window pane of the present invention is more particularly adapted to cover an opening formed in a large window of a motorized vehicle and which is positioned adjacent a conductor of the motorized vehicle whereby to provide access through the window by the sliding window pane. Often, during transit, the conductor of the motorized vehicle needs to communicate with a person positioned adjacent his window pane, such as when driving through highway pay tolls where there is a need to exchange information and material through the opening formed in this large window pane. To do this there is usually provided a window opening which the conductor needs to displace manually. This is distractive to the conductor as he must liberate a hand in order to operate the sliding window pane. The problem with these sliding window panes is that when the motorized vehicle is in operation it is sometimes difficult to open the sliding window with a single hand and therefore the vehicle needs to be stopped in order to open the sliding window. If it then becomes necessary to close the window because of rain, etc. then again this is demanding on the attention of the conductor and could cause serious accidents. There is therefore a need to remedy these problems.

### SUMMARY OF INVENTION

It is the feature of present invention to provide a motorized sliding window pane which substantially overcomes the above-mentioned disadvantages of the prior art.

Another feature of the present invention is to provide a motorized sliding window pane wherein the mechanism which causes the window pane to open or close is concealed within the window frame or the vehicle structure.

Another feature of the present invention is to provide a motorized sliding window pane which is operable by a switch which is operated quickly by the fingers of a vehicle conductor.

Another feature of the present invention is to provide a motorized sliding window pane and wherein the moving parts of the window pane are substantially concealed and also protected from foreign matter which could hamper the operation thereof.

According to the above features, from a broad aspect, the present invention provides a motorized sliding window pane incorporated in a window structure having a frame. The frame has a fixed window pane. An opening is provided in the fixed window pane and delineated by a secondary frame. The sliding window pane has opposed rails secured thereto. The rails are slidingly connected to associated opposed channel frame members. Flexible attachment means extends in one of the opposed frame members and has connection means connected to the rail associated therewith. An electrically operable means having switch means is provided for displacement of the attachment means to displace the sliding window pane between the associated opposed channel frame members to cover or expose the opening or a part thereof.

### BRIEF DESCRIPTION OF DRAWINGS

A preferred embodiment of the present invention will now be described with reference to the accompanying drawings in which:

FIG. 1 is a simplified plan view with parts thereof exposed showing the construction of a motorized sliding window pane incorporated in a large window and its flexible actuating cable secured to a motor drive;

FIG. 2 is a cross-section view showing the construction of the top horizontal channel frame member and its attachment to the sliding pane;

FIG. 3 is a perspective view, partly fragmented, showing the construction of the top channel frame member illustrating the elongated cylindrical channel projection;

FIG. 4 is a perspective view showing the construction of the slide arm to which the top rail is secured;

FIG. 5 is a perspective view showing the construction of the top rail; and

FIG. 6 is a simplified schematic view showing the construction of the motor driven sprocket disc gear and the flexible cable displaceably connected thereto.

### DESCRIPTION OF PREFERRED EMBODIMENTS

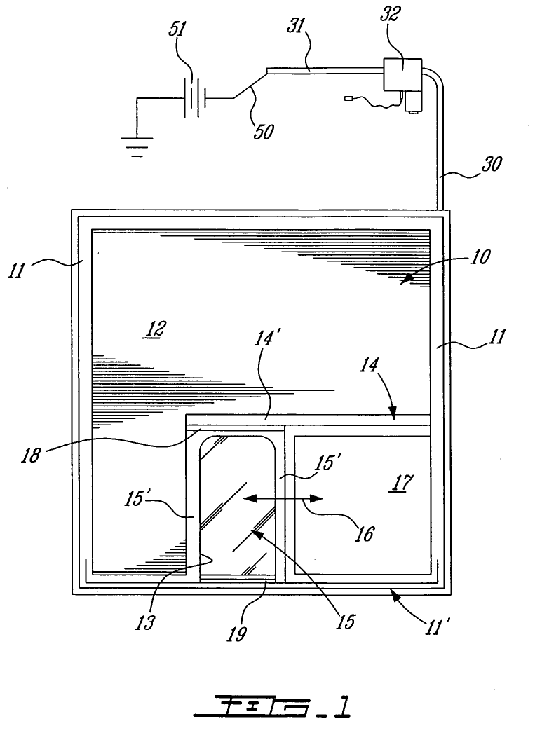

Referring now to the drawings and more particularly to FIG. 1 there is shown generally at 10 a large window having a main frame 11 in which a fixed window pane 12 is secured. An opening 13 is provided in the fixed window pane 12 and delineated by a secondary frame structure 14. The secondary frame is secured adjacent an interior surface of the fixed windows pane 12. The secondary frame structure supports a sliding a window pane 15 slidingly displaced in the secondary frame structure in the directions as indicated by arrow 16. As herein shown a second fixed window pane 17 is secured in the secondary frame structure 14.

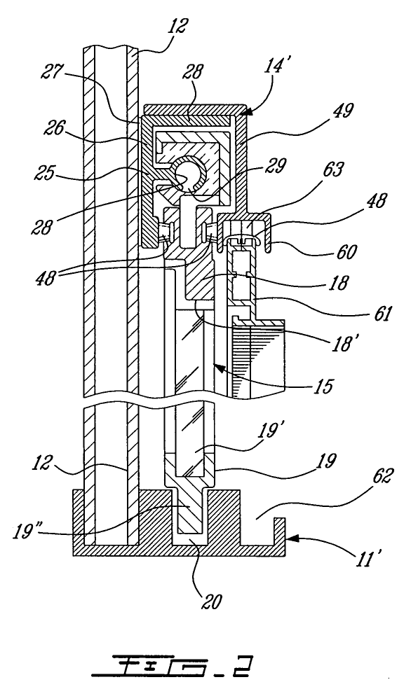

Referring now additionally to FIGS. 2 to 5 there will be described the construction of the sliding window pane 15 and its securement to the secondary frame structure 14. As shown in FIG. 2 the sliding window pane 15 has opposed rails, namely a top rail 18 and a bottom rail 19 secured along its opposed top and bottom horizontal edges 18′ and 19′. These rails are slidingly connected to opposed associated channel frame members. The top rail 18 is connected to the top horizontal secondary channel frame member 14′ and the bottom rail 19 is slidingly captive in a guide channel 20 of a bottom channel frame member 11′ of the secondary frame 11 by a depending flange 19″.

The top channel frame member 14′ is comprised of an L-shape extrusion 25 having a flat connecting rear wall 26 which is adhesively secured by an adhesive 27 to the main window pane 12 and a transverse front projecting top flange 28 extending therefrom. An elongated cylindrical guide channel is formed integral with the extrusion and extends forwardly from the flat connecting rear wall 26 and spaced from the top flange 28. An elongated slot 29 extends along the guide channel in a lower part thereof.

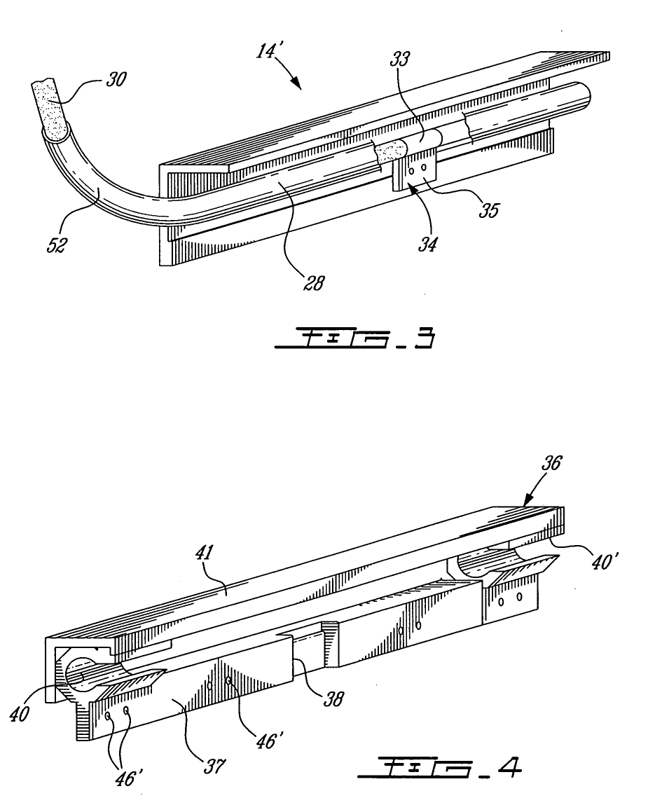

As shown in FIG. 3 a flexible cable 30 extends into the guide channel 28 and constitutes a flexible attachment means to connect to the displaceable window pane 15 to displace same. This flexible cable 30 is coupled at one end portion thereof, namely end portion 31, as shown in FIG. 1, to a drive gear of an electric motor 32. This electric motor constitutes electrically operable means for displacing the displaceable frame. The other end of the flexible cable 30, namely, end 33, as shown in FIG. 3, is connected to a connecting bracket 34 which has a flange portion 35 extending through the elongated slot 29 formed at the base of the guide channel 28. The flange portion 35 connects to the top rail 18 through a slide arm 36 as shown in FIG. 4. The slide arm 36 is slidingly displaceable over the guide channel 28 and displaceable therealong. The slide arm has a depending connecting wall 37 provided with a connecting means, in the form of an opening 38 which is dimensioned for close-fit reception of the flange portion 35 of the connecting bracket 34. The slide arm 36 is also slidingly retained over the guide channel 28 by means of a pair of guide cylinders 40 and 40′ secured at opposed ends thereof. A right angle face plate 41 is clampingly secured over these cylinders which are formed integral with the connecting wall 37.

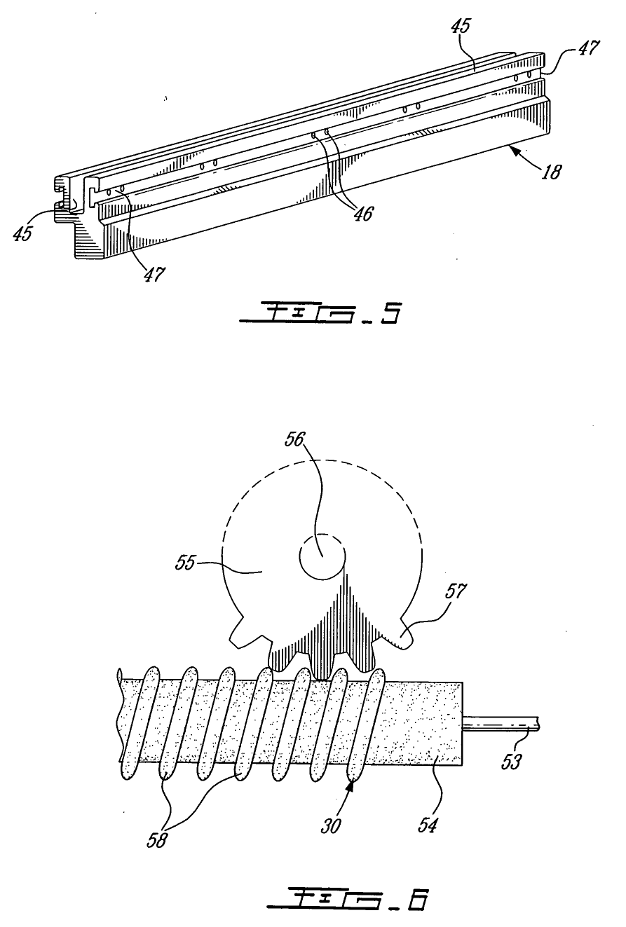

As shown in FIG. 5 the top rail 18 is provided with a top channel 45 for securement to the depending connecting wall 37 with the flange portion 35 captive in the opening 38. The wall 37 is secured in the channel 45 by fasteners not shown) extending through the holes 46 and 46′ provided both in the top rail 18 and in the connecting wall 37, respectively. The top rail channel 45 thus retains the connecting flange portion 35 of the bracket 34 captive within the opening 39 of the connecting wall 37. Accordingly, when the bracket 34 is displaced by the cable, the slide arm is also displaced as well as the sliding window pane 15 which is connected thereto via the top rail 18. The bottom rail 19 is simply guided in the guide channel 20 of the bottom frame member 11′.

As shown in FIG. 2 the glass of the sliding window pane 15 is held captive by the horizontal rails 18 and 19 and opposed vertical rails 15′.

As shown in FIG. 1 the electric motor 32 is connected to a switch 50 which is operated by a person whereby to provide electric power from a battery 51 to the motor to displace the cable 30 within the guide channel 28. As shown in FIGS. 1 and 3 the flexible cable 30 is concealed within the main frame 11 and is guided around bends by arcuate guide channels 52, as shown in FIG. 3, to have a smooth travel around sharp corners. The electric motor 32 and the portion of the cable which protrudes out of the main frame are concealed within the wall structure surrounding the main frame.

With reference to FIG. 6 there is shown the construction of the cable and the manner in which it is displaced. The flexible cable 30 is comprised of a flexible wire rod 53 which is concealed by a flexible, sound-absorbing, spring support jacket 54 and a flexible spiral spring is disposed about this jacket. A toothed disc gear 55 is secured to the drive shaft 56 of the electric motor and displaces the cable due to its coupling between the circumferential teeth of 57 the gear 55 which are dimensioned and spaced for engagement between the windings 58 of the spiral spring 30, as herein shown.

As shown in FIG. 2 the top rail 18 is also provided with opposed weather seal receiving channels 47 to receive in sliding fit therein the weather seals 48, as illustrated in FIG. 2 and well known in the art. As also shown in FIG. 2, a screen support extrusion 49 is secured to top wall 28 of the L-shape extrusion 25 and provided with a screen retention channel 60 therein to receive a screen 61 for removable securement between the channel 60 and a bottom channel 62 formed in the bottom frame member 11′. Top leaf springs 63 biases the screen frame 61 between the channels 60 and 62 as obvious to a person skilled in the art.

Although this specific embodiment relates to a sliding window pane incorporated into a large window secured to a motorized vehicle adjacent a conductor thereof, it is within the ambit of the present invention to incorporate this sliding window pane in other window structures.

It is with ambit of the present invention to cover any obvious modifications over the preferred embodiment described herein provided such modifications follow within the appended claims.

We claim:

1. A motorized sliding window pane incorporated in a window structure having a main frame, said main frame having a fixed window pane, an opening in said fixed window pane delineated by a secondary frame structure, said sliding window pane having opposed rails secured thereto, said rails being slidingly connected to associated opposed channel frame members, flexible attachment means extending in one of said opposed frame members and having connection means connected to said rail associated therewith and electrically operable means having switch means for displacement of said attachment means to displace said sliding window pane between said associated opposed channel frame members to cover or expose said opening or a part thereof.

2. A motorized sliding window pane as claimed in claim 1 wherein said secondary frame is disposed adjacent an interior surface of said fixed window pane.

3. A motorized sliding window pane as claimed in claim 1 wherein said window structure is that of a motor vehicle and situated to a side of a vehicle operator of said motor vehicle.

4. A motorized sliding window pane as claimed in claim 2 wherein said secondary frame comprises a top and a bottom horizontal one of said opposed channel frame members.

5. A motorized sliding window pane as claimed in claim 4 wherein said flexible attachment means extends in a guide channel secured in said top horizontal frame member.

6. A motorized sliding window pane as claimed in claim 5 wherein said flexible attachment means is a flexible cable coupled at one end portion thereof to a cable displacement means operatively connected to a drive gear of an electric motor constituting said electrically operable means, and connected at an opposed end to said connection means.

7. A motorized sliding window pane as claimed in claim 6 wherein said connection means is a connecting bracket having a flange portion extending through an elongated slot formed in said guide channel, said flange portion being connected to a top one of said rails whereby to displace said top rail along said top horizontal channel frame member to displace said sliding window pane connected thereto, said bottom rail having a flange extending into said bottom horizontal channel for guiding said sliding window pane therealong.

8. A motorized sliding window pane as claimed in claim 7 wherein said guide channel is an elongated cylindrical channel projecting from a flat connecting rear wall of said top frame member, said top rail being connected to a slide arm slidingly displaceable about said elongated cylindrical channel, a depending connecting wall connected to said slide arm and having connecting means for engagement by said flange portion.

9. A motorized sliding window pane as claimed in claim 8 wherein said connecting means is an opening in said depending connecting wall dimensioned for close-fit reception of said flange portion, said top rail having a top channel for securement to said depending connecting wall with said flange portion held captive in said channel.

10. A motorized sliding window pane as claimed in claim 9 wherein said depending connecting wall is fastened in said top channel by fasteners.

11. A motorized sliding window pane as claimed in claim 6 wherein said electric motor is concealed in a vehicle frame adjacent said window structure, said flexible cable being comprised of a flexible wire rod covered by a flexible, sound-absorbing, spring support jacket, and a flexible spiral spring about said jacket.

12. A motorized sliding window pane as claimed in claim 11 wherein said cable displacement means is a toothed disc gear having circumferential teeth dimensioned and spaced for engagement between windings of said spiral spring for axial displacement of said cable.
